(19) United States
(12) Patent Application Publication
(10) Pub. No.: US 2026/0054491 A1
(43) Pub. Date: Feb. 26, 2026

(54) NEGATIVE PRESSURE REGULATION VALVE AND INKJET RECORDING APPARATUS INCLUDING THE SAME

(71) Applicant: KYOCERA Document Solutions Inc., Osaka (JP)

(72) Inventors: Shun TSUBOI, Osaka (JP); Kenichi SATAKE, Osaka (JP); Shogo YONEDA, Osaka (JP); Hideki ISHIDA, Osaka (JP)

(73) Assignee: KYOCERA Document Solutions Inc., Osaka (JP)

(21) Appl. No.: 19/295,100

(22) Filed: Aug. 8, 2025

(30) Foreign Application Priority Data
Aug. 21, 2024 (JP) 2024-139431

(51) Int. Cl. B41J 2/175

(52) U.S. Cl. CPC B41J 2/17596; B41J 2/17556

(57) ABSTRACT

A negative pressure regulation valve includes a pressure chamber, a valve member, a diaphragm portion, a pressure receiving plate, and a biasing member. The pressure chamber has a liquid inflow port, and a liquid outflow port formed above the liquid inflow port. The pressure receiving plate is displaced with the diaphragm portion to the inside and the outside of the pressure chamber, thereby changing a capacity of the pressure chamber. The valve member is caused to move with the pressure receiving plate to a closing position for closing the ink inflow port and an opening position for opening the ink inflow port. When the pressure receiving plate is displaced to the inside and the outside of the pressure chamber, the capacity of the pressure chamber changes by a larger amount from an upper part toward a lower part of the pressure chamber with respect to a direction of gravity.

### INCORPORATION BY REFERENCE

This application is based on and claims the benefit of priority from Japanese Patent Application No. 2024-139431 filed on August 21, 2024, the contents of which are hereby incorporated by reference.

### BACKGROUND

The present disclosure relates to a negative pressure regulation valve for use in an inkjet recording apparatus, and an inkjet recording apparatus including the negative pressure regulation valve.

In inkjet recording apparatuses, it is important to constantly maintain the ink ejection state and conditions to ensure high print quality. For this purpose, a configuration is adopted in which an ink flow path connecting an ink container and a recording head is provided with a pressure regulating portion (a negative pressure regulation valve, a damper, or the like) that regulates pressure by storing ink.

### SUMMARY

According to one aspect of the present disclosure, a negative pressure regulation valve is connected to a liquid flow path that allows communication between a liquid reservoir portion, which contains a liquid, and a liquid ejection portion, which ejects the liquid. The negative pressure regulation valve includes a pressure chamber, a valve member, a diaphragm portion, a pressure receiving plate, and a biasing member. The pressure chamber includes a liquid inflow port that communicates with a liquid inflow path that is the liquid flow path on a side of the liquid reservoir portion, and a liquid outflow port that communicates with a liquid outflow path that is the liquid flow path on a side of the liquid ejection portion. The valve member is disposed at the liquid inflow port and movable, in accordance with change of pressure inside the pressure chamber, to a closing position for closing the liquid inflow port and an opening position for opening the liquid inflow port. The diaphragm portion constitutes part of pressure chamber and is displaced to an inside and an outside of the pressure chamber along with change of pressure inside the pressure chamber. The pressure receiving plate is disposed opposite an inside surface of the diaphragm portion and is displaced with the diaphragm portion to the inside and the outside of the pressure chamber, thereby changing a capacity of the pressure chamber. The biasing member biases the pressure receiving plate in a direction of displacing the receiving plate to the outside of the pressure chamber. By displacement of the diaphragm portion to the inside of the pressure chamber and displacement of the pressure receiving plate to the outside of the pressure chamber that is due to a biasing force of the biasing member, the valve member is caused to move with the pressure receiving plate to the closing position and the opening position. When the pressure receiving plate is displaced to the inside and the outside of the pressure chamber, the capacity of the pressure chamber changes by a larger amount from an upper part toward a lower part of the pressure chamber with respect to a direction of gravity.

### BRIEF DESCRIPTION OF THE DRAWINGS

FIG. 1 is an explanatory diagram schematically illustrating a configuration of a printer as an inkjet recording apparatus according to one embodiment of the present disclosure.

FIG. 2 is a plan view of a recording portion that the printer includes.

FIG. 3 is a schematic configuration diagram illustrating an arrangement of an ink flow path, a negative pressure regulation valve, and a recording head, the latter two being connected to the ink flow path.

FIG. 4 is an exterior perspective view of a negative pressure regulation valve according to one embodiment of the present disclosure.

FIG. 5 is a side sectional view of the negative pressure regulation valve of the present embodiment that includes an ink inflow port and an ink outflow port.

FIG. 6 is a side sectional view of the negative pressure regulation valve including the ink inflow port and the ink outflow port, illustrating how liquid is discharged from the negative pressure regulation valve.

### DETAILED DESCRIPTION

### [1. Configuration of Inkjet Recording Apparatus]

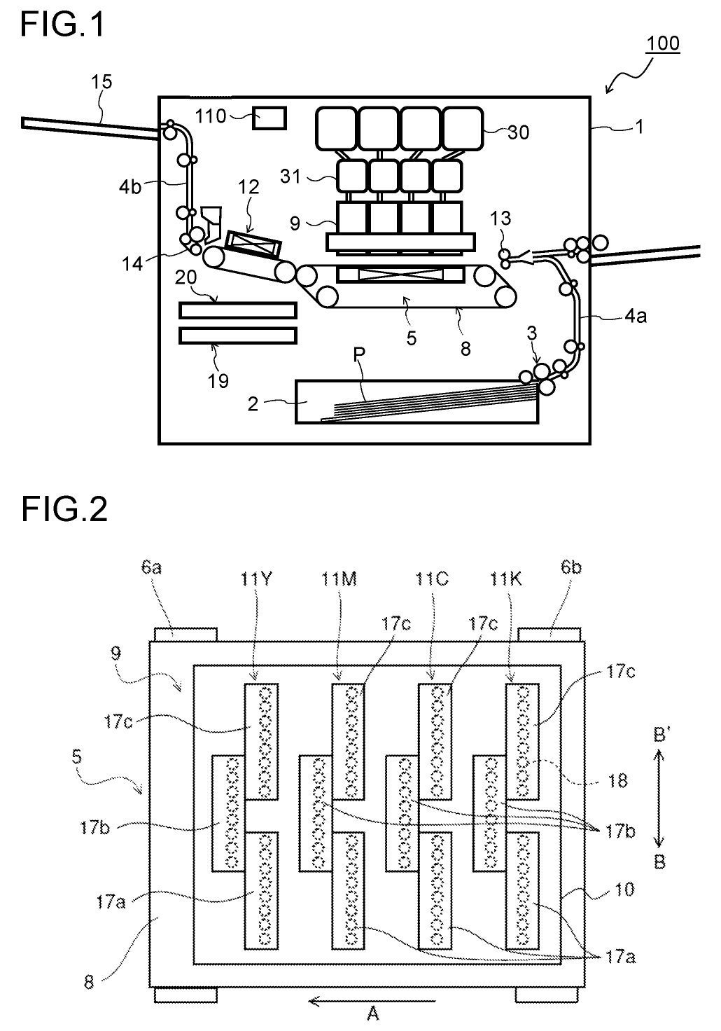

Hereinafter, an embodiment of the present disclosure will be described with reference to the accompanying drawings. FIG. 1 is an explanatory diagram schematically illustrating a configuration of a printer 100 as an inkjet recording apparatus according to one embodiment of the present disclosure. The printer 100 includes a sheet feeding cassette 2 that is a sheet storage portion. The sheet feeding cassette 2 is disposed in a lower part inside a printer main body 1. Inside the sheet feeding cassette 2, a sheet P is stored as one example of a recording medium.

On a downstream side of the sheet feeding cassette 2 in a sheet conveyance direction, that is, on an upper right side of the sheet feeding cassette 2 in FIG. 1, a sheet feeding device 3 is disposed. By the sheet feeding device 3, sheets P are sent out, one by one separately, toward the upper right side of the sheet feeding cassette 2 in FIG. 1.

The printer 100 includes a first sheet conveyance path 4a disposed inside thereof. The first sheet conveyance path 4a is disposed, with respect to the sheet feeding cassette 2, on the upper right side, toward which a sheet P is fed from the sheet feeding cassette 2. A sheet P sent out from the sheet feeding cassette 2 is, by the first sheet conveyance path 4a, conveyed vertically upward along a side surface of the printer main body 1.

At a downstream end of the first sheet conveyance path 4a in the sheet conveyance direction, a pair of registration rollers 13 are disposed. Furthermore, immediately close to the pair of registration rollers 13 on a downstream side thereof in the sheet conveyance direction, a first conveyance unit 5 and a recording portion 9 are disposed. A sheet P sent out from the sheet feeding cassette 2 passes through the first sheet conveyance path 4a and reaches the pair of registration rollers 13. The pair of registration rollers 13, while correcting skew feeding of the sheet P, send out the sheet P toward the first conveyance unit 5 (in particular, a first conveyance belt 8 which will be described later), with timing coordinated with an ink ejecting operation that the recording portion 9 executes.

FIG. 2 is a plan view of the recording portion 9. The recording portion 9 includes a head housing 10 and line heads 11Y, 11M, 11C, and 11K. The line heads 11Y to 11K are held in the head housing 10 at such a height that maintains a predetermined distance (e.g., 1 mm) from a conveyance surface of the first conveyance belt 8, which is an endless belt stretched by a plurality of rollers including a driving roller 6a, a driven roller 6b, and a tension roller (unillustrated). The driving roller 6a causes the first conveyance belt 8 to rotate in the conveyance direction (an arrow-A direction) of a sheet P.

The line heads 11Y to 11K each have a plurality of (here, three) recording heads 17a to 17c. The recording heads 17a to 17c are arranged in a staggered manner along a sheet width direction (an arrow-BB' direction) that is orthogonal to the sheet conveyance direction (the arrow-A direction). The recording heads 17a to 17c each have a plurality of ink ejection ports 18 (nozzles).

The ink ejection ports 18 are arranged at regular intervals in a recording-head width direction, that is, the sheet width direction (the arrow-BB' direction). From each of the line heads 11Y to 11K, via the ink ejection ports 18 of the recording heads 17a to 17c, ink in yellow (Y), magenta (M), cyan (C), or black (K) is ejected toward the sheet P conveyed by the first conveyance belt 8.

The recording heads 17a to 17c constituting each of the line heads 11C to 11K are supplied, from an ink container 30 (see FIG. 1), with ink in one of the four colors (yellow, magenta, cyan, and black) corresponding to the colors of the line heads 11C to 11K. Between the ink container 30 and the recording heads 17a to 17c, a negative pressure regulation valve 31 (see FIG. 1) is connected. A detailed configuration of the negative pressure regulation valve 31 will be described later.

Based on a control signal from a control device 110 (see FIG. 1), each of the recording heads 17a to 17c, in accordance with image data received from an external computer, ejects ink through the ink ejection ports 18 toward a sheet P, which is conveyed by being held by suction on the conveyance surface of the first conveyance belt 8. Thereby, on the sheet P held on the first conveyance belt 8, a color image is formed by superimposing inks in yellow, magenta, cyan, and black on one another.

Referring back to FIG. 1, the sheet P having been sent out by the pair of registration rollers 13 to the first conveyance unit 5 is conveyed by the first conveyance belt 8 to a position opposite the recording portion 9 (in particular, the recording heads 17a to 17c, which will be described later). By the recording portion 9 ejecting ink onto the sheet P, an image is recorded on the sheet P. The ejection of ink in the recording portion 9 is controlled by the control device 110 incorporated in the printer 100.

In the sheet conveyance direction, on a downstream side (a left side in FIG. 1) of the first conveyance unit 5, a second conveyance unit 12 is disposed. The sheet P, having had an image recorded thereon by the recording portion 9, is then sent to the second conveyance unit 12. The ink having been ejected onto a surface of the sheet P is dried while the sheet P is passing through the second conveyance unit 12.

In the sheet conveyance direction, at a position that is downstream of the second conveyance unit 12 and close to a left side surface of the printer main body 1, a decurler portion 14 is disposed. The sheet P, having had the ink dried through the second conveyance unit 12, is then sent to the decurler portion 14, where a curl having been generated in the sheet P is corrected.

In the sheet conveyance direction, at a position that is downstream of (in FIG. 1, above) the decurler portion 14, a second sheet conveyance path 4b is disposed. After passing through the decurler portion 14, if no duplex recording is to be performed, the sheet P passes through the second sheet conveyance path 4b, and is discharged onto a sheet discharge tray 15 disposed on an outside of the left side surface of the printer 100.

Further, below the second conveyance unit 12, a maintenance unit 19 and a cap unit 20 are disposed. When a purge is executed, the maintenance unit 19 horizontally moves to a position under the recording portion 9, wipes ink discharged through the ink ejection ports 18 of the recording heads 17a to 17c, and collects the wiped ink. Here, a purge refers to an operation of discharging thickened ink, foreign matter, bubbles, etc., from inside the ink ejection ports 18 by forcibly discharging ink from the ink ejection ports 18 of the recording heads 17a to 17c. To cap ink ejection surfaces of the recording heads 17a to 17c, the cap unit 20 horizontally moves to a position under the recording portion 9, and then further moves upward to be attached to lower surfaces of the recording heads 17a to 17c.

### [2. Configuration of Ink Flow Path including Negative Pressure Regulation Valve]

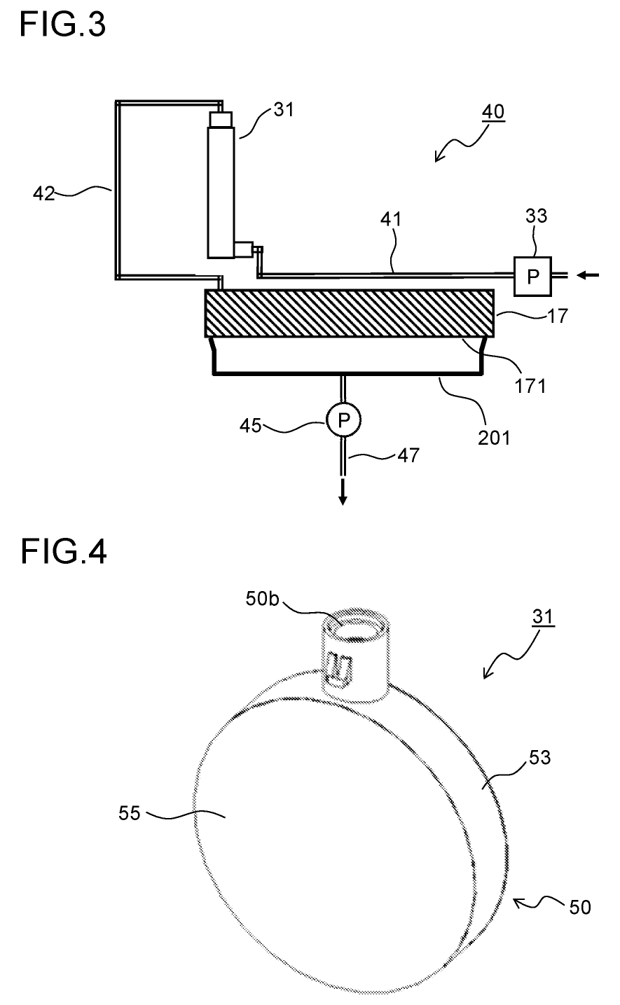

FIG. 3 is a schematic configuration diagram illustrating an arrangement of an ink flow path 40, a negative pressure regulation valve 31, and a recording head 17, the latter two being connected to the ink flow path 40. In the following description, the recording heads 17a to 17c will be simply referred to as the recording head 17. Further, up-down directions in FIGS. 3 and 4 correspond to a vertical direction (a direction of gravity).

The ink flow path 40 includes an ink inflow path 41 and an ink outflow path 42. Between the ink inflow path 41 and the ink outflow path 42, the negative pressure regulation valve 31 is connected.

Ink having been introduced from the ink container 30 (see FIG. 1) into the ink flow path 40 is supplied to the recording head 17 via the ink inflow path 41, the negative pressure regulation valve 31, and the ink outflow path 42. To the ink inflow path 41, a pressure pump 33 is connected. The pressure pump 33 maintains a constant pressure inside a pressure chamber 50 (see FIG. 4) of the negative pressure regulation valve 31.

Note that a configuration may be adopted in which the pressure pump 33 is not provided and the ink container 30 is disposed at a position higher than the negative pressure regulation valve 31 to use hydraulic head pressure of ink to maintain constant pressure inside the pressure chamber 50. In a case where a sub tank (unillustrated) is disposed between the ink container 30 and the negative pressure regulation valve 31, the sub tank is located at a position higher than the negative pressure regulation valve 31.

To the recording head 17, the cap 201 is attached. The cap 201 is supported in the cap unit 20 (see FIG. 1), and is attached to an ink ejection surface (nozzle surface) 171 of the recording head 17 when no printing process is to be executed for a certain period of time or longer. In the cap 201, a flow path (unillustrated) is provided that communicates with atmosphere. This flow path is openable and closable so that change of temperature in a space between the ink ejection surface 171 and the cap 201 will not cause excessive change of pressure in the ink ejection ports (nozzles) 18 of the recording head 17. With the cap 201 attached, the ink ejection surface 171 of the recording head 17 is maintained in a sealed state. To the cap 201, a suction pump 45 and a waste ink discharge path 47 are connected.

In the printer 100, in order to remove dried or thickened ink, foreign matter, etc., from inside the ink ejection ports 18 (see FIG. 2) of the recording head 17, when printing is started after a long period of stop, and between printing operations, the suction pump 45 performs, with the cap 201 attached to the ink ejection surface 171 and the flow path communicating with atmosphere closed, a suction purge process by sucking air from the space (sealed space) between the ink ejection surface 171 and the cap 201 to forcibly suck out ink from all the ink ejection ports 18 of the recording head 17, so as to be ready for the next printing operation. The ink (purged ink) having been sucked out from the recording head 17 into an inside of the cap 201 is discharged by the suction pump 45 to an outside of the cap 201, and is then collected via the waste ink discharge path 47 in a waste ink tank (unillustrated).

The suction purge process is also executed when initially filling the ink flow path 40 with an initial filling liquid or ink, when replacing the initial filling liquid in the ink flow path 40 with the ink, and when discharging air, foreign matter, etc., from inside the ink flow path 40.

In the present embodiment, the ink outflow path 42 communicates with the recording head 17. In this configuration, a liquid inside the ink outflow path 42 is sucked out by the suction pump 45 via the recording head 17 to flow out into the waste ink discharge path 47. Thus, at the ink ejection ports (nozzles) 18 of the recording head 17, the liquid constantly flows from inside to outside the nozzles. Consequently, even if the suction pump 45 generates a negative pressure with an increased absolute value, there is no risk of a meniscus inside the ink ejection ports 18 being drawn to allow entry of bubbles into the ink ejection ports 18.

### [3. Configuration of Negative Pressure Regulation Valve]

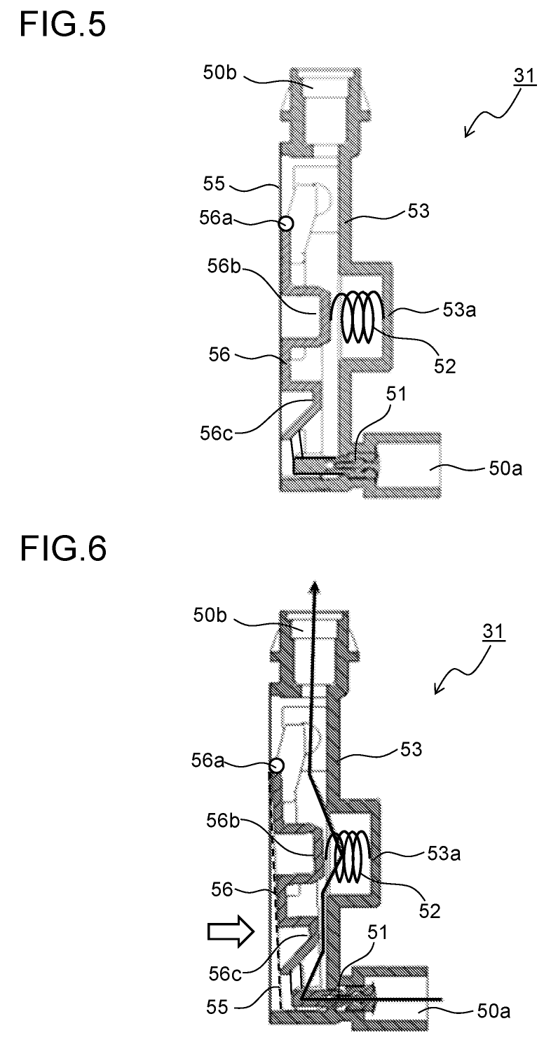

FIG. 4 is an exterior perspective view of a negative pressure regulation valve 31 according to one embodiment of the present disclosure. FIG. 5 is a side sectional view of the negative pressure regulation valve 31 of the present embodiment that includes an ink inflow port 50a and an ink outflow port 50b. The negative pressure regulation valve 31 stores therein ink that flows in the ink flow path 40, and also functions as a pressure regulation valve that opens and closes the ink flow path 40 in accordance with pressure on a side of the recording head 17. The negative pressure regulation valve 31 includes a pressure chamber 50, a valve member 51, and an opening/closing pressure regulation spring 52.

The pressure chamber 50 includes a main body portion 53, a diaphragm portion 55, and a pressure receiving plate 56. The main body portion 53 is cylinder-shaped, having an opening formed in one side surface thereof (a left side surface thereof in FIG. 5), and includes the ink inflow port 50a and the ink outflow port 50b. To the ink inflow port 50a, the ink inflow path 41 is connected. To the ink outflow port 50b, the ink outflow path 42 is connected. The ink outflow port 50b is formed at a position higher than the ink inflow port 50a.

In the present embodiment, the ink inflow port 50a is formed at a lower end part of the pressure chamber 50, and the ink outflow port 50b is formed at an upper end part of the pressure chamber 50. The pressure chamber 50 has a predetermined capacity for storing ink having flowed into it through the ink inflow port 50a. The main body portion 53 includes a recessed portion 53a formed, in a surface thereof (a right side surface thereof in FIG. 5) opposite the diaphragm portion 55 so as to be recessed from an inside of the pressure chamber 50 toward an outside of the pressure chamber 50.

The diaphragm portion 55 is formed of a flexible resin film having a multi-layer structure. The diaphragm portion 55 is fixed to the opening of the side surface (the left side surface in FIG. 5) of the main body portion 53 with a predetermined amount of slack, and constitutes an outside surface of the pressure chamber 50. The diaphragm portion 55 is displaced in accordance with change of pressure inside the pressure chamber 50, thereby changing the capacity of the pressure chamber 50.

The pressure receiving plate 56 is supported in the main body portion 53 so as to be swingable about a swing fulcrum 56a formed at an upper end part thereof. The pressure receiving plate 56 is in contact with an inner side surface (a resin layer facing the inside of the pressure chamber 50) of the diaphragm portion 55, and swings in accordance with displacement of the diaphragm portion 55.

The pressure receiving plate 56 includes a first protruding portion 56b and a second protruding portion 56c, which protrude from the outside toward the inside of the pressure chamber 50. The first protruding portion 56b is formed at a substantially central part of the pressure chamber 50 in the up-down direction. The first protruding portion 56b is formed at a position opposite the recessed portion 53a formed in the main body portion 53.

Between the first protruding portion 56b and the recessed portion 53a, the opening/closing pressure regulation spring 52 is disposed. Due to a biasing force of the opening/closing pressure regulation spring 52, the pressure receiving plate 56 receives a force in a direction of displacing (inflating) the diaphragm portion 55 outward.

The second protruding portion 56c is formed below the first protruding portion 56b but above the ink inflow port 50a. Due to the second protruding portion 56c formed in the pressure receiving plate 56, the capacity of the pressure chamber 50 is, in a state before the diaphragm portion 55 is displaced to the inside of the pressure chamber 50, smaller on a side near the ink inflow port 50a (that is, the upper side with respect to the direction of gravity) than on a side near the ink outflow port 50b (that is, the lower side with respect to the direction of gravity).

At the ink inflow port 50a, the valve member 51 is disposed that is capable of opening and closing the ink inflow port 50a. To the pressure receiving plate 56, one end part of the valve member 51 inserted in the ink inflow port 50a is connected. The valve member 51 is movable, in accordance with the displacement of the pressure receiving plate 56 caused along with the change of pressure inside the pressure chamber 50, to a closing position for closing the ink inflow port 50a and an opening position for opening the ink inflow port 50a against the biasing force of the opening/closing pressure regulation spring 52.

FIG. 6 is a side sectional view of the negative pressure regulation valve 31 including the ink inflow port 50a and the ink outflow port 50b, illustrating how liquid (initial filling liquid or ink) is discharged from the negative pressure regulation valve 31. An arrow in FIG. 6 indicates a flow of the liquid inside the negative pressure regulation valve 31.

When ink is consumed in the recording head 17 and the pressure is reduced inside the pressure chamber 50, the diaphragm portion 55 is displaced inward (deflated). Along with the displacement of the diaphragm portion 55, the pressure receiving plate 56 swings inward against the biasing force of the opening/closing pressure regulation spring 52. As a result, a lower end part of the pressure receiving plate 56 presses the valve member 51 toward a side of the ink inflow port 50a (the opening position) to open the ink inflow port 50a. As a result, ink is supplied through the ink inflow path 41 to the pressure chamber 50. Then, when a predetermined negative pressure is achieved inside the pressure chamber 50, the valve member 51 is pressed back to the inside of the pressure chamber 50 (the closing position) to close the ink inflow port 50a, thereby stopping the supply of ink through the ink inflow path 41 to the pressure chamber 50. In this manner, pressure is regulated to supply ink to the recording head 17.

To execute the suction purge process, in a state where the ink ejection surface 171 of the recording head 17 is covered with the cap 201 (see FIG. 3 for both) and the flow path allowing communication between the inside of the cap 201 and atmosphere is closed, the suction pump 45 is operated to suck air from the space (the sealed space) between the ink ejection surface 171 and the cap 201 to generate a negative pressure.

As a result, a negative pressure is generated inside the pressure chamber 50 of the negative pressure regulation valve 31, and the diaphragm portion 55 is displaced inward (deflated). Along with the displacement of the diaphragm portion 55, the pressure receiving plate 56 swings inward against the biasing force of the opening/closing pressure regulation spring 52. As a result, the valve member 51 moves to the side of the ink inflow port 50a to open the ink inflow port 50a, allowing communication between the pressure chamber 50 and the ink inflow path 41. Thereby, the liquid flows from the ink container 30, via the ink inflow path 41, the negative pressure regulation valve 31, and the ink outflow path 42, into the recording head 17, and the liquid inside the recording head 17 is discharged through the ink ejection ports 18.

At this time, a bubble contained in the liquid flowing into the pressure chamber 50 stays in an upper part of the pressure chamber 50. Thus, the bubble efficiently flows out from the ink outflow port 50b formed in the upper part of the pressure chamber 50, via the ink outflow path 42, into the recording head 17.

Further, as a result of a lower part of the pressure receiving plate 56 swinging (moving) toward the inside of the pressure chamber 50 due to the change of pressure inside the pressure chamber 50, the first protruding portion 56b approaches the recessed portion 53a of the main body portion 53, and the second protruding portion 56c approaches an inner side surface of the main body portion 53. As a result, an ink flow path in a lower part inside the pressure chamber 50 becomes narrower than an ink flow path in an upper part.

In other words, the capacity of the pressure chamber 50 reduces more significantly in the lower part thereof than in the upper part thereof with respect to the direction of gravity (the up-down direction). That is, when the pressure receiving plate 56 is displaced to the inside and the outside of the pressure chamber 50, the capacity of the pressure chamber 50 changes by a larger amount from the upper part toward the lower part of the pressure chamber 50. As a result, a flow speed of the liquid flowing inside the pressure chamber 50 from the ink inflow port 50a toward the ink outflow port 50b increases.

Solid matter, such as a solidified ink component, foreign matter, etc., included in the liquid that is caused by the suction purge process to flow from the ink inflow port 50a into the pressure chamber 50 stays in the lower part of the pressure chamber 50. Thus, the increased flow speed of the liquid inside the pressure chamber 50 helps the solid matter to efficiently flow out from the ink outflow port 50b formed in the upper part of the pressure chamber 50, via the ink outflow path 42, into the recording head 17.

With the configuration of the present embodiment, in a case where the suction purge process is executed prior to shipment of the printer 100 to thereby fill the ink flow path 40, in an empty state, with ink or the initial filling liquid, a bubble contained in the ink or the initial filling liquid is efficiently discharged through the ink outflow port 50b formed at the upper end part of the pressure chamber 50.

Furthermore, also in a case where the suction purge process is executed when the printer 100 is installed so as to replace the initial filling liquid inside the ink flow path 40 with the ink, the initial filling liquid, which has a lower density than the ink, efficiently flows out from the ink outflow port 50b, and thus does not stay inside the pressure chamber 50. Thus, it is possible to reduce an amount of ink to flow when replacing the initial filling liquid inside the ink flow path 40 with the ink.

Moreover, in a case where the suction purge process is executed to discharge a solidified ink component or foreign matter staying inside the ink flow path 40 while the printer 100 is in use, the pressure receiving plate 56 is displaced so as to make the ink flow path in the lower part narrower than the ink flow path in the upper part inside the pressure chamber 50 to thereby increase the flow speed of the liquid. This allows a solidified ink component, foreign matter, and the like to flow out from the ink outflow port 50b smoothly and efficiently, without staying in the lower part of the pressure chamber 50.

That is, solid matter, liquid with high specific gravity, and the like flow out from the ink outflow port 50b with improved efficiency, which makes it possible to reduce the amount of ink to be used in the suction purge process. This enables the negative pressure regulation valve 31 to effectively prevent a bubble from staying, and liquid from stagnating, inside the pressure chamber 50. Furthermore, since no solid matter stays inside the pressure chamber 50, it is possible to avoid a problem where solid matter becomes stuck in a gap between the valve member 51 and the ink inflow port 50a, preventing the valve member 51 from moving.

Further, by forming the recessed portion 53a in the main body portion 53 and forming the first protruding portion 56b in the pressure receiving plate 56, it is possible to secure sufficient space for disposing the opening/closing pressure regulation spring 52 while minimizing the capacity of the lower part of the pressure chamber 50. Further, by forming the second protruding portion 56c in the pressure receiving plate 56, the capacity of the lower part of the pressure chamber 50 is further reduced when the pressure receiving plate 56 is displaced to the inside of the pressure chamber 50. This helps further increase the flow speed of the liquid inside the pressure chamber 50.

Further, forming the ink inflow port 50a at the lower end part of the pressure chamber 50 helps eliminate the risk of thickened ink and foreign matter with high specific gravity staying in the lower part of the pressure chamber 50. Further, with the ink outflow port 50b formed at the upper end part of the pressure chamber 50, there is no risk of a bubble and an initial filling liquid with low specific gravity staying in the upper part of the pressure chamber 50. This enables the negative pressure regulation valve 31 to more effectively prevent a bubble from staying, and liquid from stagnating, inside the pressure chamber 50.

It should be understood that the present disclosure is not limited to the above embodiments, and various modifications are possible within the scope of the present disclosure. For example, in the above embodiments, the swing fulcrum 56a of the pressure receiving plate 56 is positioned below the ink outflow port 50b at a predetermined distance. However, the position of the swing fulcrum 56a is not limited to the position as described in the above embodiments, and the swing fulcrum 56a may be positioned below and closer to the ink outflow port 50b. That is, any configuration may be adopted as long as the capacity of the pressure chamber 50 becomes smaller from the upper part toward the lower part of the pressure chamber 50 when the pressure receiving plate 56 is displaced to the inside of the pressure chamber 50.

Further, in the above embodiment, between the first protruding portion 56b formed in the pressure receiving plate 56 and the recessed portion 53a formed in the main body portion 53, the opening/closing pressure regulation spring 52 is disposed, but the first protruding portion 56b and the recessed portion 53a are not essential components, and the opening/closing pressure regulation spring 52 may be disposed at another position. Further, the second protruding portion 56c may be omitted, or instead, two or more second protruding portions 56c may be formed.

Further, exemplified in the above embodiments as components connected to the ink flow path 40 are the recording head 17, the negative pressure regulation valve 31, the pressure pump 33, and the suction pump 45, but the present disclosure is applicable to configurations where other components are connected to the ink flow path 40.

Further, described in the above embodiments is an example where used as an inkjet recording apparatus is a color printer which records color images using inks in four colors, but the negative pressure regulation valve 31 of the present embodiment is usable also in a case where a monochrome printer is used which records a monochrome image using a black ink.

The present disclosure is usable in a negative pressure regulation valve connected between a liquid reservoir portion such as an ink container and a liquid ejection portion such as a recording head, and in an inkjet recording apparatus such as an inkjet printer that includes the negative pressure regulation valve.

What is claimed is:

1. A negative pressure regulation valve connected to a liquid flow path that allows communication between a liquid reservoir portion, which contains a liquid, and a liquid ejection portion, which ejects the liquid, the negative pressure regulation valve comprising:
a pressure chamber including
a liquid inflow port that communicates with a liquid inflow path that is the liquid flow path on a side of the liquid reservoir portion,
and a liquid outflow port that is formed above the liquid inflow port and that communicates with a liquid outflow path that is the liquid flow path on a side of the liquid ejection portion;
a valve member that is disposed at the liquid inflow port and that is movable, in accordance with change of pressure inside the pressure chamber, to a closing position for closing the liquid inflow port and to an opening position for opening the liquid inflow port;
a diaphragm potion that constitutes part of the pressure chamber and that is displaced, along with the change of pressure inside the pressure chamber, to an inside and an outside of the pressure chamber;
a pressure receiving plate that is disposed opposite an inside surface of the diaphragm portion and that is displaced with the diaphragm portion to the inside and the outside of the pressure chamber, thereby changing a capacity of the pressure chamber; and
a biasing member that biases the pressure receiving plate in a direction of displacing the pressure receiving plate to the outside of the pressure chamber,
wherein
by displacement of the diaphragm portion to the inside of the pressure chamber and displacement of the pressure receiving plate to the outside of the pressure chamber that is due to a biasing force of the biasing member, the valve member is caused to move with the pressure receiving plate to the closing position and the opening position, and
when the pressure receiving plate is displaced to the inside and the outside of the pressure chamber, the capacity of the pressure chamber changes by a larger amount from an upper part toward a lower part thereof with respect to a direction of gravity.

2. The negative pressure regulation valve according to claim 1,
wherein
the pressure receiving plate is supported so as to be swingable about an upper end part thereof, functioning as a swing fulcrum, in directions toward the inside and the outside of the pressure chamber, and when the diaphragm portion is displaced to the inside of the pressure chamber, a lower end part of the pressure receiving plate swings to the inside of the pressure chamber, such that the capacity of the pressure chamber is reduced by a larger amount from the upper part of the pressure chamber toward the lower part of the pressure chamber.

3. The negative pressure regulation valve according to claim 1,
wherein
the pressure chamber includes a main body portion having an opening formed in one side thereof, the diaphragm portion is fixed to the opening with a predetermined amount of slack,
the main body portion includes a recessed portion formed in a shape recessed from the inside of the pressure chamber toward the outside of the pressure chamber, the pressure receiving plate includes a first protruding portion formed in a shape protruding from the outside of the pressure chamber toward the inside of the pressure chamber, and the biasing member is disposed between the recessed portion and the first protruding portion.

4. The negative pressure regulation valve according to claim 3, wherein in a state before the diaphragm portion is displaced to the inside of the pressure chamber, the capacity of the pressure chamber is smaller below the first protruding portion than above the first protruding portion.

5. The negative pressure regulation valve according to claim 4, wherein the pressure receiving plate includes at least one second protruding portion formed below the first protruding portion in a shape protruding from the outside of the pressure chamber toward the inside of the pressure chamber.

6. The negative pressure regulation valve according to claim 1, wherein the liquid inflow port is formed at a lower end part of the pressure chamber, and the liquid outflow port is formed at an upper end part of the pressure chamber.

7. An inkjet recording apparatus, comprising:
an ink container that contains ink that is a liquid;
at least one recording head including a plurality of nozzles that eject the ink; and
the negative pressure regulation valve according to claim 1 connected to an ink flow path between the ink container and the at least one recording head.
